(19) United States
(12) Patent Application Publication
(10) Pub. No.: US 2022/0258573 A1
(43) Pub. Date: Aug. 18, 2022

(54) COMPONENT FOR VEHICLE INTERIOR

(71) Applicant: Shanghai Yanfeng Jinqiao Automotive Trim Systems Co. Ltd., Novi, MI (US)

(72) Inventor: Tang Yucheng, Shanghai (CN)

(21) Appl. No.: 17/730,577

(22) Filed: Apr. 27, 2022

Related U.S. Application Data
(63) Continuation-in-part of application No. PCT/CN2020/120210, filed on Oct. 10, 2020.

(30) Foreign Application Priority Data
Oct. 31, 2019 (CN) 201911054614.7
Oct. 31, 2019 (CN) 201921859026.6

(51) Int. Cl. B60H 1/34

(52) U.S. Cl. CPC B60H 1/3428

(57) ABSTRACT

An air outlet assembly for airflow in a vehicle interior is disclosed. The air outlet assembly may comprise a housing providing an outlet, a vertical guide assembly to guide airflow toward the outlet, and a diverter to guide airflow through the outlet. The diverter may to direct air from an inlet of the housing to the vertical guide assembly. The vertical guide assembly may comprise a set of vertical guides that pass through the diverter. The diverter may surround the set of vertical guides. The diverter may comprise a rear portion between an inlet of the housing and the set of vertical guides and a front portion between the set of vertical guides and the outlet. The diverter may translate relative to the set of vertical guides; the set of vertical guides may rotate relative to the diverter.

### CROSS-REFERENCE TO RELATED APPLICATIONS

The present application is a continuation-in-part of PCT/International Patent Application No. PCT/CN2020/120210 filed Oct. 10, 2020, which claims priority to Chinese Patent Application No. 201911054614.7 filed Oct. 31, 2019 and Chinese Utility Model Application No. 201921859026.6 filed Oct. 31, 2019 (now Chinese Utility Model No. 210911949U).

The present application claims priority to and incorporates by reference in full the following patent applications: (a) Chinese Patent Application No. 201911054614.7 filed Oct. 31, 2019; (b) Chinese Utility Model Application No. 201921859026.6 filed Oct. 31, 2019 (now Chinese Utility Model No. 210911949U); (c) PCT/International Patent Application No. PCT/CN2020/120210 filed Oct. 10, 2020.

### FIELD

The present invention relates to a component for a vehicle interior.

The present invention also relates to a component for a vehicle interior comprising an air outlet assembly.

### BACKGROUND

It is known to provide an air outlet in a vehicle interior with a control to direct airflow.

It would be advantageous to provide an improved component for a vehicle interior comprising an air outlet assembly for airflow.

It would also be advantageous to provide an improved component for a vehicle interior comprising an air outlet assembly for airflow providing a housing providing an outlet, a vertical guide assembly configured to guide airflow through the outlet, and a diverter configured to guide airflow through the outlet.

### SUMMARY

The present invention relates to an air outlet assembly for airflow in a vehicle interior comprising a housing providing an outlet, a vertical guide assembly configured to guide airflow toward the outlet, and a diverter configured to guide airflow through the outlet. The diverter may be configured to direct air from an inlet of the housing to the vertical guide assembly. The vertical guide assembly may comprise a set of vertical guides. The set of vertical guides may pass through the diverter. The diverter may surround the set of vertical guides. The diverter may comprise (a) a rear portion between an inlet of the housing and the set of vertical guides and (b) a front portion between the set of vertical guides and the outlet. The front portion and the rear portion may be configured to translate relative to the housing and the set of vertical guides. The diverter may be configured to translate in a vertical direction between a raised position and a lowered position. The set of vertical guides may be configured to direct air side to side; the diverter may be configured to direct air up and down. The diverter may be configured to translate relative to the set of vertical guides; the set of vertical guides may be configured to rotate relative to the diverter. A guide of the set of vertical guides may be configured to rotate along a path; the diverter may comprise a curved surface aligned with the path.

The present invention relates to an air outlet assembly for airflow in a vehicle interior comprising a housing providing an outlet, a vertical guide assembly configured to guide airflow toward the outlet, and a diverter comprising a rear portion and a front portion. The rear portion may be configured to direct air from an inlet toward the vertical guide assembly. The front portion may be configured to guide airflow through the outlet. The vertical guide assembly may be configured to guide airflow between the rear portion and the front portion. The vertical guide assembly may be configured to guide airflow above the diverter; the vertical guide assembly may be configured to guide airflow below the diverter. The diverter may comprise a unitary component comprising a wall connecting the front portion and the rear portion; the wall, the front portion and the rear portion may form an opening for the vertical guide assembly. The vertical guide assembly may comprise a set of vertical guides configured to rotate relative to the diverter between a first terminal position and a second terminal position; the diverter may be configured to translate relative to the set of vertical guides between a lowered position and a raised position. The vertical guide assembly may comprise a set of vertical guides; the set of vertical guides may extend above the diverter; the set of vertical guides may extend below the diverter.

The present invention relates to an air outlet assembly for airflow in a vehicle interior comprising a housing, at least one set of air guide blades inside the housing, and an air guide block inside the housing. The air guide block may be configured to translate relative to the at least one set of air guide blades. The at least one set of air guide blades may be configured to rotate relative to the air guide block. The air guide block may comprise an opening; the at least one set of air guide blades may be in the opening. The at least one set of air guide blades may comprise an air guide blade comprising a shaft configured to rotate the air guide blade relative to the air guide block to adjust a direction of air flow through the housing. The at least one set of air guide blades may comprise a first air guide blade and a second air guide blade; the first air guide blade may comprise a first set of ribs; the second air guide blade may comprise a second set of ribs; the first set of ribs may be staggered with the second set of ribs. The at least one set of air guide blades may comprise an air guide blade comprising a rib; the rib may comprise a profile substantially identical to a profile of the air guide block. The air guide block may comprise a plurality of continuous curved surfaces partially defining the opening, a profile of a single curved surface of the plurality of continuous curved surfaces may be substantially identical to a rotation trajectory of an air guide blade of the at least one set of air guide blades. The at least one set of air guide blades may comprise a first set of air guide blades and a second set of air guide blades. The air guide block may be configured to translate in a vertical direction relative to the at least one set of air guide blades between a raised position and a lowered position.

The present invention relates to an air outlet assembly comprising a housing and an air guide block assembled inside the housing. The air guide block may comprise a well. At least one set of air guide blades may be in the well to enable the air guide block to move longitudinally relative to the air guide blades. The air guide blade may comprise a blade rotating shaft extending in a vertical direction so that a single air guide blade may rotate around the blade rotating shaft. The air guide blade may comprise a plurality of sets of ribs with different heights, and the ribs on adjacent air guide blades may be interleaved. A profile of the rib may be substantially identical to an outer profile of an outer surface of the air guide block. At least one set of ribs may be substantially aligned with the upper or lower surfaces at a periphery of an opening of the well with respect to each longitudinal position of the air guide block. The opening side of the well may comprise a plurality of continuous curved surfaces. Two ends of the single curved surface may correspond to a limit rotation position of the single air guide blade. The profile of the single curved surface may be substantially identical to the rotation trajectory of the air guide blades. The guide blades may comprise two sets of air guide blades. A blade rotating shaft extending in a horizontal direction may be provided on an air guide blade so that the air guide blade rotates around the blade rotating shaft.

### FIGURES

FIG. 1A is a schematic perspective view of a vehicle according to an exemplary embodiment.

FIG. 1B is a schematic partial perspective view of a vehicle interior according to an exemplary embodiment.

FIG. 1C is a schematic partial perspective view of a component for a vehicle interior according to an exemplary embodiment.

FIG. 1D is a schematic partial perspective view of a component for a vehicle interior according to an exemplary embodiment.

FIG. 2A is a schematic perspective view of a component for a vehicle interior according to an exemplary embodiment.

FIG. 2B is a schematic exploded perspective view of a component for a vehicle interior according to an exemplary embodiment.

FIGS. 3A through 3C are schematic front views of a component for a vehicle interior according to an exemplary embodiment.

FIGS. 4A through 4D are schematic partial perspective views of a component for a vehicle interior according to an exemplary embodiment.

FIG. 5A is a schematic partial perspective view of a component for a vehicle interior according to an exemplary embodiment.

FIG. 5B is a schematic partial exploded perspective view of a component for a vehicle interior according to an exemplary embodiment.

FIG. 6 is a schematic partial perspective view of a component for a vehicle interior according to an exemplary embodiment.

FIG. 7 is a schematic partial perspective view of a component for a vehicle interior according to an exemplary embodiment.

FIGS. 8A through 8C are schematic section views of a component for a vehicle interior according to an exemplary embodiment.

FIGS. 9A through 9C are schematic section views of a component for a vehicle interior according to an exemplary embodiment.

FIG. 10 is a schematic section view of a component for a vehicle interior according to an exemplary embodiment.

FIG. 11 is a schematic perspective view of a component for a vehicle interior according to an exemplary embodiment.

FIG. 12 is a schematic exploded perspective view of a component for a vehicle interior according to an exemplary embodiment.

FIGS. 13A through 13C are schematic front views of a component for a vehicle interior according to an exemplary embodiment.

FIGS. 14A through 14D are schematic partial perspective views of a component for a vehicle interior according to an exemplary embodiment.

FIG. 15 is a schematic partial perspective view of a component for a vehicle interior according to an exemplary embodiment.

FIG. 16 is a schematic partial exploded perspective view of a component for a vehicle interior according to an exemplary embodiment.

FIG. 17 is a schematic partial exploded perspective view of a component for a vehicle interior according to an exemplary embodiment.

FIGS. 18A through 18C are schematic section views of a component for a vehicle interior according to an exemplary embodiment.

FIGS. 19A through 19C are schematic section views of a component for a vehicle interior according to an exemplary embodiment.

FIG. 20 is a schematic section view of a component for a vehicle interior according to an exemplary embodiment.

### DESCRIPTION

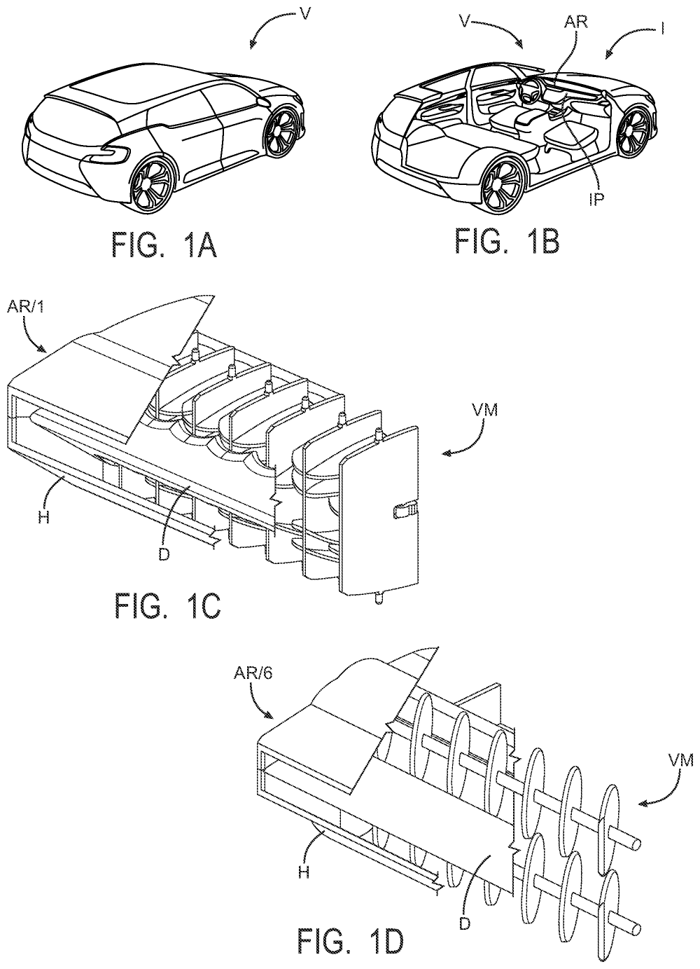

Referring to FIGS. 1A-1B and 1C-1D, a vehicle V is shown with an interior I providing an instrument panel IP comprising a component shown as air outlet assembly AR configured to provide airflow (i.e. from the vehicle heating/cooling and ventilation system) into interior I of vehicle V.

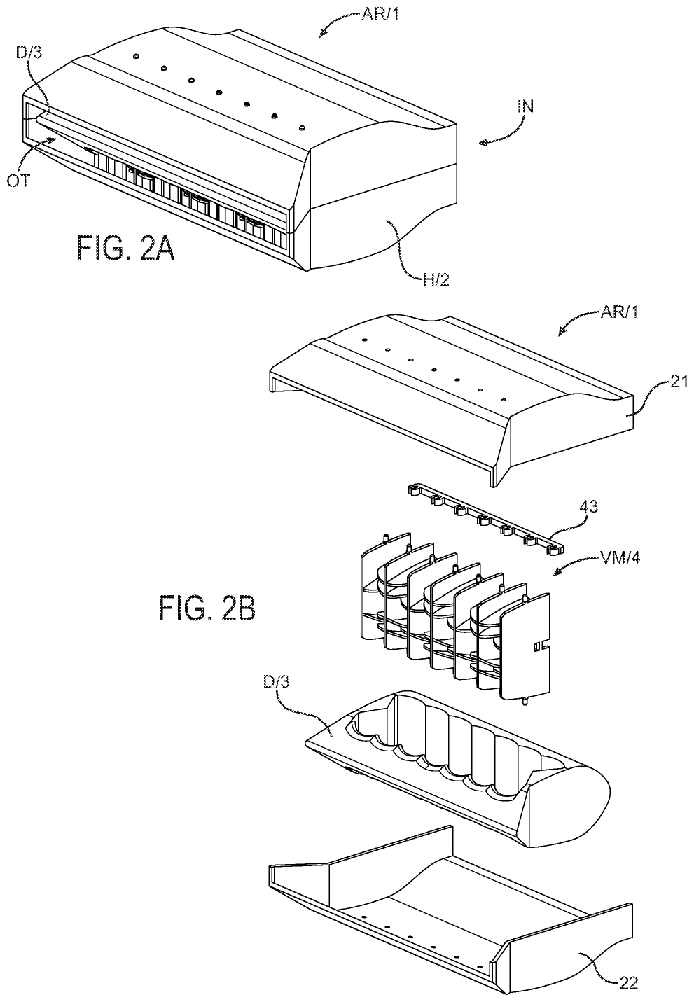

According to an exemplary embodiment as shown schematically in FIGS. 2A-2B, 3A-3C, 4A-4D, 5A-5B, 6, 7, 8A-8C, 9A-9C and 10, an air outlet assembly AR/1 for airflow in a vehicle interior may comprise a housing H/2 providing an outlet OT, a vertical guide assembly VM/4 configured to guide airflow toward the outlet, and a diverter D/3 configured to guide airflow through the outlet. The diverter may be configured to direct air from an inlet IN of the housing to the vertical guide assembly. The vertical guide assembly may comprise a set of vertical guides. The set of vertical guides may pass through the diverter. The diverter may surround the set of vertical guides. The diverter may comprise (a) a rear portion between an inlet of the housing and the set of vertical guides and (b) a front portion between the set of vertical guides and the outlet. The front portion and the rear portion may be configured to translate relative to the housing and the set of vertical guides. The diverter may be configured to translate in a vertical direction between a raised position and a lowered position. The set of vertical guides may be configured to direct air side to side; the diverter may be configured to direct air up and down. The diverter may be configured to translate relative to the set of vertical guides; the set of vertical guides may be configured to rotate relative to the diverter. A guide of the set of vertical guides may be configured to rotate along a path; the diverter may comprise a curved surface aligned with the path.

According to an exemplary embodiment as shown schematically in FIGS. 2A-2B, 3A-3C, 4A-4D, 5A-5B, 6, 7, 8A-8C, 9A-9C and 10, an air outlet assembly AR/1 for airflow in a vehicle interior may comprise a housing H/2 providing an outlet OT, a vertical guide assembly VM/4 configured to guide airflow toward the outlet, and a diverter D/3 comprising a rear portion and a front portion. The rear portion may be configured to direct air from an inlet IN toward the vertical guide assembly. The front portion may be configured to guide airflow through the outlet. The vertical guide assembly may be configured to guide airflow between the rear portion and the front portion. The vertical guide assembly may be configured to guide airflow above the diverter; the vertical guide assembly may be configured to guide airflow below the diverter. The diverter may comprise a unitary component comprising a wall connecting the front portion and the rear portion; the wall, the front portion and the rear portion may form an opening for the vertical guide assembly. The vertical guide assembly may comprise a set of vertical guides configured to rotate relative to the diverter between a first terminal position and a second terminal position; the diverter may be configured to translate relative to the set of vertical guides between a lowered position and a raised position. The vertical guide assembly may comprise a set of vertical guides; the set of vertical guides may extend above the diverter; the set of vertical guides may extend below the diverter.

According to an exemplary embodiment as shown schematically in FIGS. 2A-2B, 3A-3C, 4A-4D, 5A-5B, 6, 7, 8A-8C, 9A-9C and 10, an air outlet assembly AR/1 for airflow in a vehicle interior may comprise a housing H/2, a vertical guide assembly VM/4 inside the housing, and a diverter D/3 inside the housing. Vertical guide assembly VM/4 may comprise at least one set of air guide blades. Diverter D/3 may comprise an air guide block. The air guide block may be configured to translate relative to the at least one set of air guide blades. The at least one set of air guide blades may be configured to rotate relative to the air guide block. The air guide block may comprise an opening; the at least one set of air guide blades may be in the opening. The at least one set of air guide blades may comprise an air guide blade comprising a shaft configured to rotate the air guide blade relative to the air guide block to adjust a direction of air flow through the housing. The at least one set of air guide blades may comprise a first air guide blade and a second air guide blade; the first air guide blade may comprise a first set of ribs; the second air guide blade may comprise a second set of ribs; the first set of ribs may be staggered with the second set of ribs. The at least one set of air guide blades may comprise an air guide blade comprising a rib; the rib may comprise a profile substantially identical to a profile of the air guide block. The air guide block may comprise a plurality of continuous curved surfaces partially defining the opening, a profile of a single curved surface of the plurality of continuous curved surfaces may be substantially identical to a rotation trajectory of an air guide blade of the at least one set of air guide blades. The air guide block may be configured to translate in a vertical direction relative to the at least one set of air guide blades between a raised position and a lowered position.

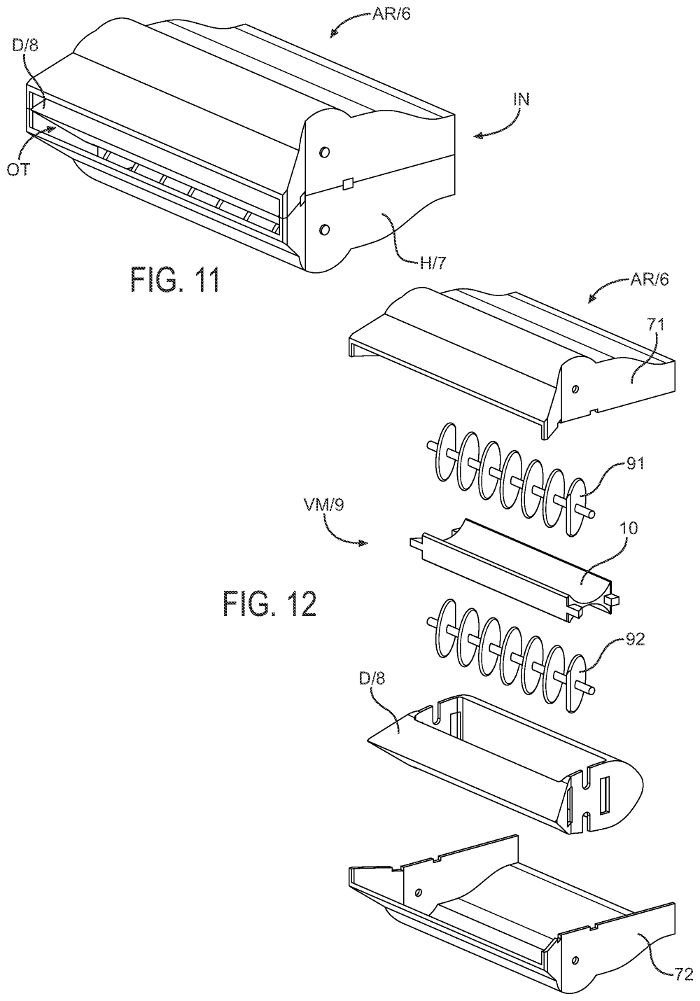

According to an exemplary embodiment as shown schematically in FIGS. 11, 12, 13A-13C, 14A-14D, 15, 16, 17, 18A-18C, 19A-19C and 20, an air outlet assembly AR/6 for airflow in a vehicle interior may comprise a housing H/7 providing an outlet OT, a vertical guide assembly VM configured to guide airflow toward the outlet, and a diverter D/8 configured to guide airflow through the outlet. The diverter may be configured to direct air from an inlet of the housing to the vertical guide assembly. The vertical guide assembly may comprise a set of vertical guides. The set of vertical guides may pass through the diverter. The diverter may surround the set of vertical guides. The diverter may comprise (a) a rear portion between an inlet of the housing and the set of vertical guides and (b) a front portion between the set of vertical guides and the outlet. The front portion and the rear portion may be configured to translate relative to the housing and the set of vertical guides. The diverter may be configured to translate in a vertical direction between a raised position and a lowered position. The diverter may be configured to direct air from an inlet of the housing to the vertical guide assembly; the set of vertical guides may be configured to direct air side to side; the diverter may be configured to direct air to outlet. The diverter may be configured to translate relative to the set of vertical guides; the set of vertical guides may be configured to rotate relative to the diverter. A guide of the set of vertical guides may be configured to rotate along a path; the diverter may comprise a curved surface aligned with the path.

According to an exemplary embodiment as shown schematically in FIGS. 11, 12, 13A-13C, 14A-14D, 15, 16, 17, 18A-18C, 19A-19C and 20, an air outlet assembly AR/6 for airflow in a vehicle interior may comprise a housing H/7 providing an outlet OT, a vertical guide assembly VM configured to guide airflow toward the outlet, and a diverter D/8 comprising a rear portion and a front portion. The rear portion may be configured to direct air from an inlet toward the vertical guide assembly. The front portion may be configured to guide airflow through the outlet. The vertical guide assembly may be configured to guide airflow between the rear portion and the front portion. The vertical guide assembly may be configured to guide airflow above the diverter; the vertical guide assembly may be configured to guide airflow below the diverter. The diverter may comprise a unitary component comprising a wall connecting the front portion and the rear portion; the wall, the front portion and the rear portion may form an opening for the vertical guide assembly. The vertical guide assembly may comprise a set of vertical guides configured to rotate relative to the diverter between a first terminal position and a second terminal position; the diverter may be configured to translate relative to the set of vertical guides between a lowered position and a raised position. The vertical guide assembly may comprise a set of vertical guides; the set of vertical guides may extend above the diverter; the set of vertical guides may extend below the diverter.

According to an exemplary embodiment as shown schematically in FIGS. 11, 12, 13A-13C, 14A-14D, 15, 16, 17, 18A-18C, 19A-19C and 20, an air outlet assembly AR/6 for airflow in a vehicle interior may comprise a housing H/7, a vertical guide assembly VM inside the housing, and a diverter D/8 inside the housing. Vertical guide assembly VM may comprise at least one set of air guide blades. Diverter D/8 may comprise an air guide block. The air guide block may be configured to translate relative to the at least one set of air guide blades. The at least one set of air guide blades may be configured to rotate relative to the air guide block. The air guide block may comprise an opening; the at least one set of air guide blades may be in the opening. The at least one set of air guide blades may comprise an air guide blade comprising a shaft configured to rotate the air guide blade relative to the air guide block to adjust a direction of air flow through the housing. The at least one set of air guide blades may comprise a first air guide blade and a second air guide blade; the first air guide blade may comprise a first set of ribs; the second air guide blade may comprise a second set of ribs; the first set of ribs may be staggered with the second set of ribs. The at least one set of air guide blades may comprise an air guide blade comprising a rib; the rib may comprise a profile substantially identical to a profile of the air guide block. The air guide block may comprise a plurality of continuous curved surfaces partially defining the opening, a profile of a single curved surface of the plurality of continuous curved surfaces may be substantially identical to a rotation trajectory of an air guide blade of the at least one set of air guide blades. The at least one set of air guide blades may comprise a first set of air guide blades 91 and a second set of air guide blades 92. The air guide block may be configured to translate in a vertical direction relative to the at least one set of air guide blades between a raised position and a lowered position.

### Exemplary Embodiments—A

As shown schematically according to an exemplary embodiments of FIGS. 1A-1D, a vehicle V may provide an interior I with a component shown as an air outlet assembly/structure AR configured to provide for airflow.

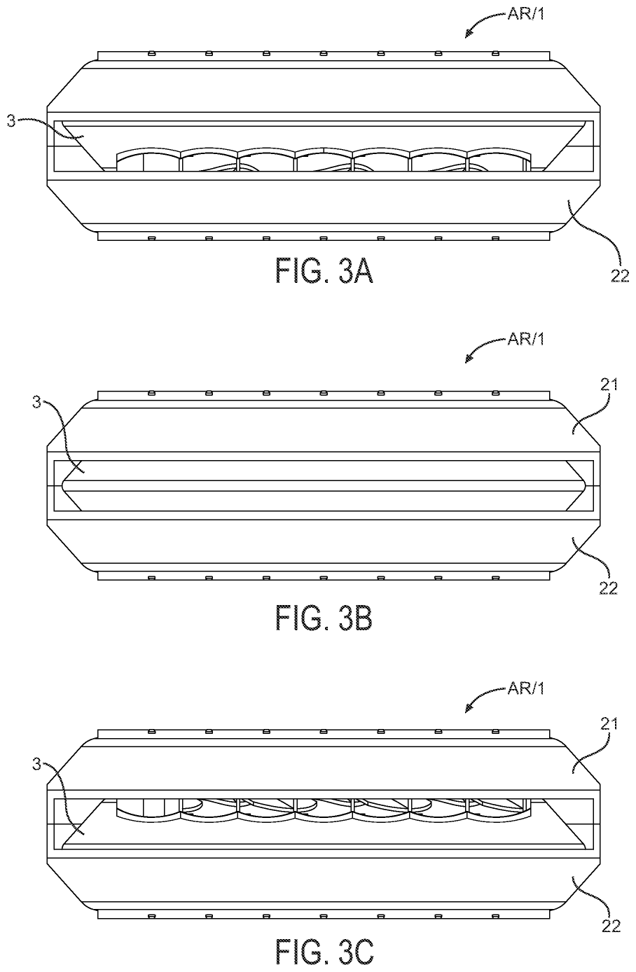

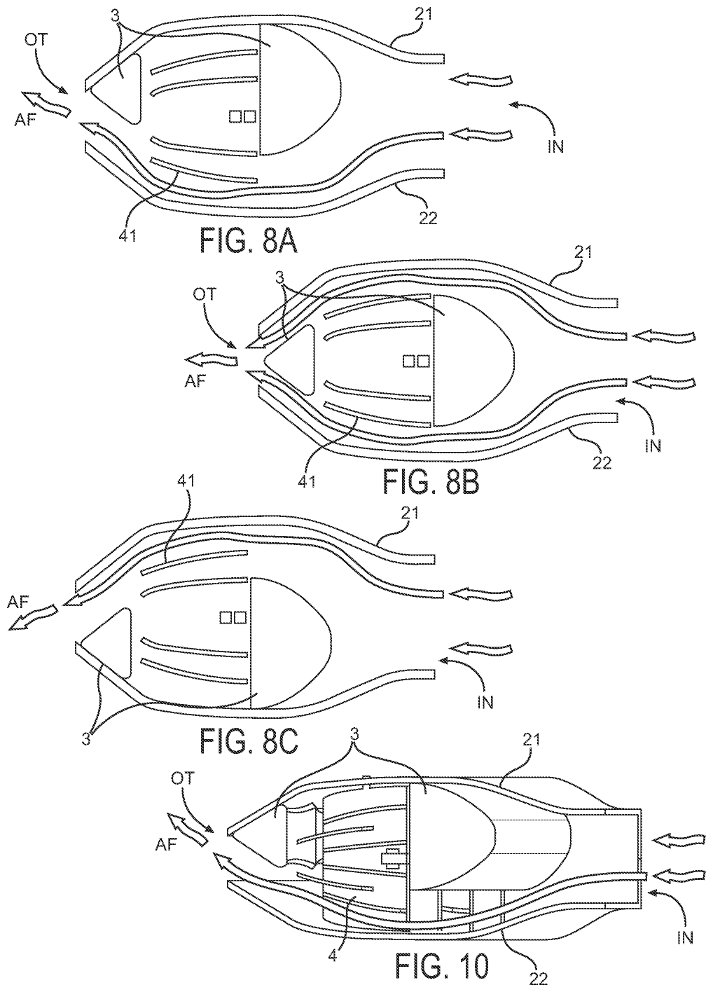

According to an exemplary embodiment as shown schematically in FIGS. 2A-2B, 3A-3C, 4A-4D, 5A-5B, 6, 7, 8A-8C, 9A-9C and 10, an air outlet AR/1 may comprise a housing H/2, a diverter D/3 and a vertical guide mechanism VM/4. Housing H/2 may comprise an upper housing 21 and a lower housing 22. Diverter D/3 may comprise air guide block. Vertical guide mechanism VM/4 may comprise an air guide blade set. When upper housing 21 and lower housing 22 are combined, slender rectangular notches may be on both sides; one side may be an air inlet side, and the other side may be an air outlet side. Diverter 3 and vertical guide mechanism 4 may be assembled inside housing H/2, and diverter 3 may divide the housing into an upper part and a lower part. As shown schematically in FIGS. 3A-3C and 8A-8C, when diverter 3 moves up and down, the ratio of the upper part and the lower part of the housing cavity may be changed to adjust the air blowing of the air outlet assembly 1 in up and down directions.

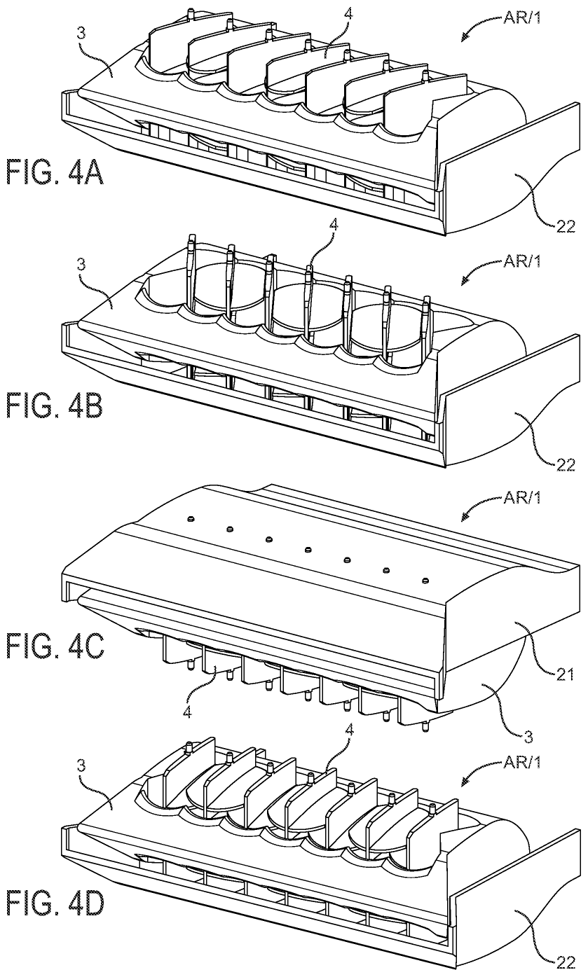

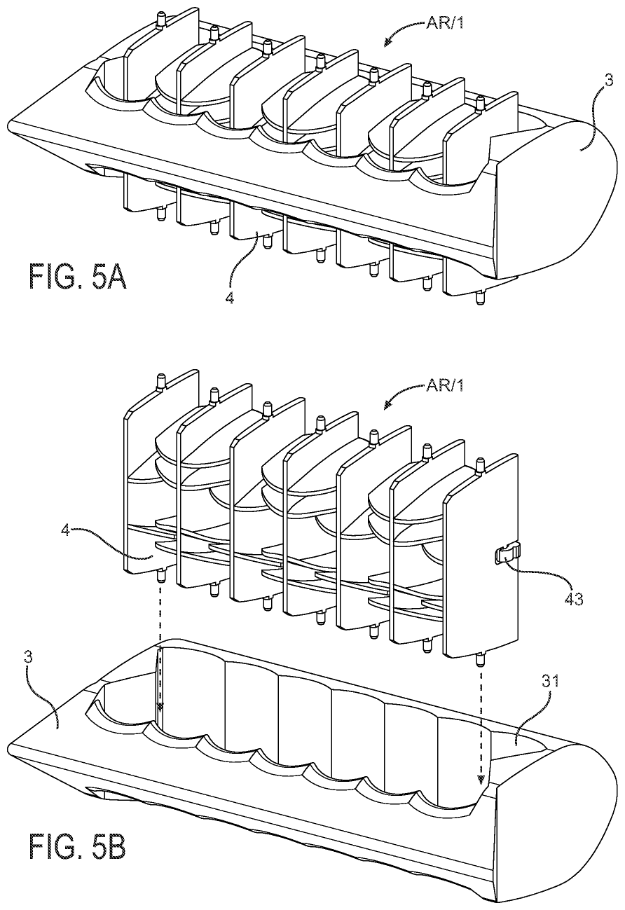

As shown schematically in FIG. 5A, diverter 3 may comprise a well 31 extending along the outline of the air guide blades, and vertical guide mechanism 4 may extend through the inside of well 31 and may rotate left and right in well 31 to regulate air blowing in left and right directions of air outlet assembly 1 as shown schematically in FIGS. 4A-4B. Sides of the opening of well 31 may comprise a plurality of continuous curved surfaces 32, the shape of which may substantially coincide with a shape of an envelope surface of motion of the blade. The well may be arranged to avoid the envelope surface of motion of the blade. The number of the curved surfaces may be consistent with the number of the air guide blades, and two ends of each curved surface may correspond to a limit rotation position of each air guide blade.

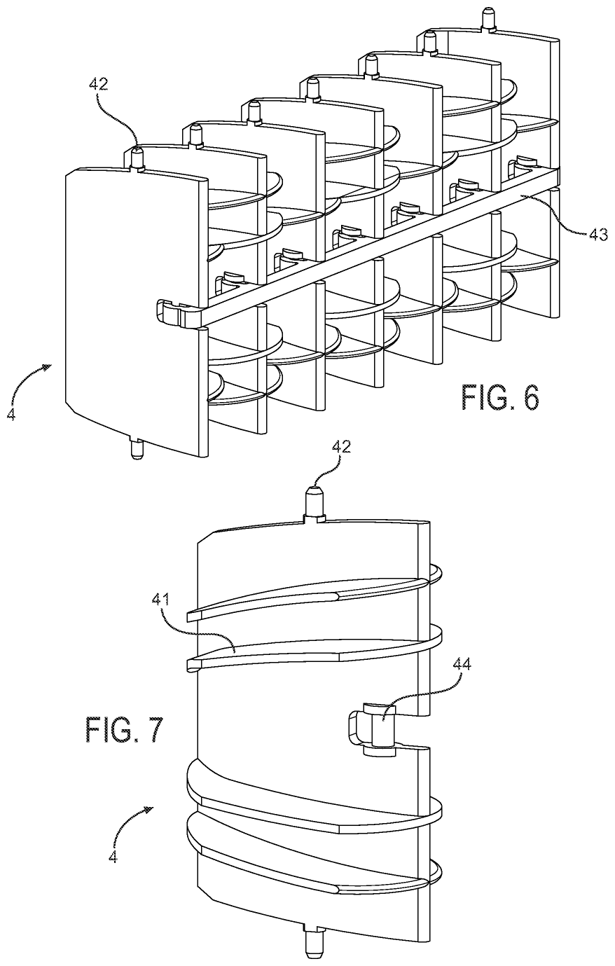

As shown schematically in FIGS. 6 and 7, blades of vertical guide mechanism 4 may be provided with a plurality of ribs 41 with different heights; ribs 41 may be for filling gaps between the air guide blades and between vertical guide mechanism 4 and diverter 3 to provide smooth air passage in the housing. An outer profile of ribs 41 may align with a corresponding outer profile of an outer surface of the air guide block. Ribs on adjacent blades may be interleaved, and ribs at the same height may be arranged in a set. At least one set of ribs may be substantially aligned with an upper or lower surface at a periphery of an opening of well 31 of diverter 3 when air guide blocks 3 are at different heights.

The air guide blade may comprise a blade rotating shaft 42 extending in a vertical direction and a blade linkage rotating shaft 44. A single blade may rotate around the blade rotating shaft 42, and a plurality of blades may form an air guide blade set by blade linkages 43 connected with the blade linkage rotating shaft 44.

When air outlet assembly 1 guides air flow in a forward direction as shown schematically in FIG. 8B, diverter 3 may be positioned in the middle of the housing, and the housing cavity may be divided into two parts which are generally equal in a vertical direction by diverter 3. After air flow enters the housing from the air inlet side of the housing, air flow may be equally divided in a vertical direction by diverter 3, air flow may converge at the air outlet side of the housing after passing through diverter 3 and vertical guide mechanism 4, and air may flow out at the air outlet side of the housing in a horizontal direction due to generally equal air flow on the upper side and the lower side. Rib 41 may fill the notch in the middle of diverter 3 to provide smooth air passage in the housing.

When air outlet assembly 1 guides air flow in an upward direction as shown schematically in FIG. 8A, diverter 3 may be located at an upper portion of the housing; an inner wall of lower housing 22 and diverter 3 may form an upward outlet at the air outlet side of the housing, and air at the lower portion of diverter 3 may flow out from the air outlet side of the housing in an upward direction. When diverter 3 is at an inner wall of upper housing 21, an upper portion of the housing cavity is closed, an upward blowing angle reaches a limit value, and the air outlet area is effectively increased.

When air outlet assembly 1 guides air flow in a downward direction as shown schematically in FIG. 8C, diverter 3 may be located at a lower portion of the housing, an inner wall of upper housing 21 and diverter 3 may form a downward outlet at the outlet side of the housing, and air at the upper portion of diverter 3 may flow out from the outlet side of the housing in a downward direction. When diverter 3 is at an inner wall of lower housing 22, a lower portion of the housing cavity is closed, the downward blowing angle reaches a limit value, and the air outlet area is effectively increased.

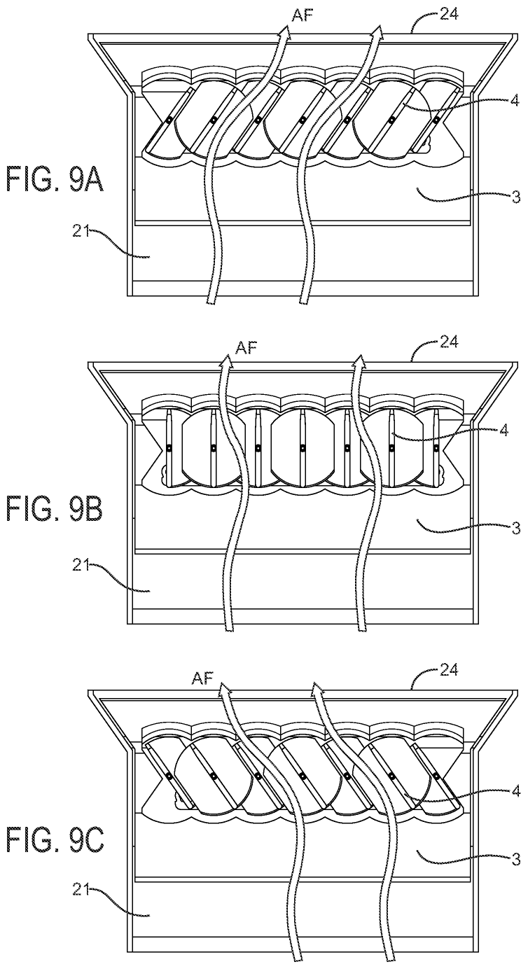

As shown schematically in FIGS. 9A-9C, vertical guide mechanism 4 may rotate leftward and rightward, and air flow may be guided by the air guide blades to deflect leftward and rightward through a clearance between the housing and diverter 3 so that leftward and rightward guided air may flow out at the air outlet side of the housing.

Rotation of vertical guide mechanism 4 along blade rotating shaft 42 and the upward and downward movement of diverter 3 do not interfere with each other, and guide the air flow leftwards and rightwards and upwards and downwards respectively. When the air outlet assembly 1 guides air flow upwards and rightwards as shown schematically in FIG. 10, diverter 3 is positioned at the upper part of the housing, and vertical guide mechanism 4 is inclined rightwards so that the air flow is guided in an upper right direction at the inclination angle of the blades. Ribs 41 may reduce the notch of well 31 of the air guide block exposed to the air passage and may smoothen air passage inside the housing, effectively guiding vertical guide mechanism 4 and reducing airflow noise.

According to an exemplary embodiment as shown schematically in FIGS. 11, 12, 13A-13C, 14A-14D, 15, 16, 17, 18A-18C, 19A-19C and 20, an air outlet assembly AR/6 may comprise a housing H/7, a diverter D/8 and a vertical guide mechanism VM. Housing H/7 may comprise an upper housing 71 and a lower housing 72. Diverter D/8 may comprise an air guide block. Vertical guide mechanism VM may comprise an air guide blade assembly 9 and a block 10. Air guide blade assembly 9 may comprise a blade rotating shaft 93 extending in a horizontal direction; blade rotating shaft 93 may extend to both sides of upper housing 71 and lower housing 72. Blade rotating shaft 93 may be arranged on a side of the housing so that a motor may be arranged on the side of the housing to reduce space occupied in a height direction of the air outlet. When upper housing 71 and lower housing 72 are combined, slender rectangular notches may be reserved on both sides; one side may be an air inlet side, and the other side may be an air outlet side.

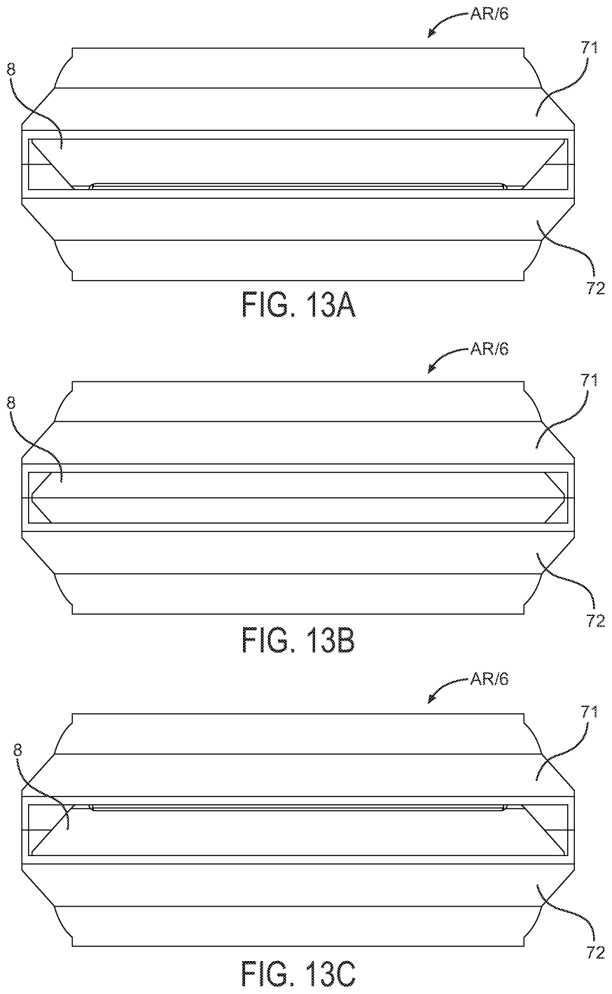

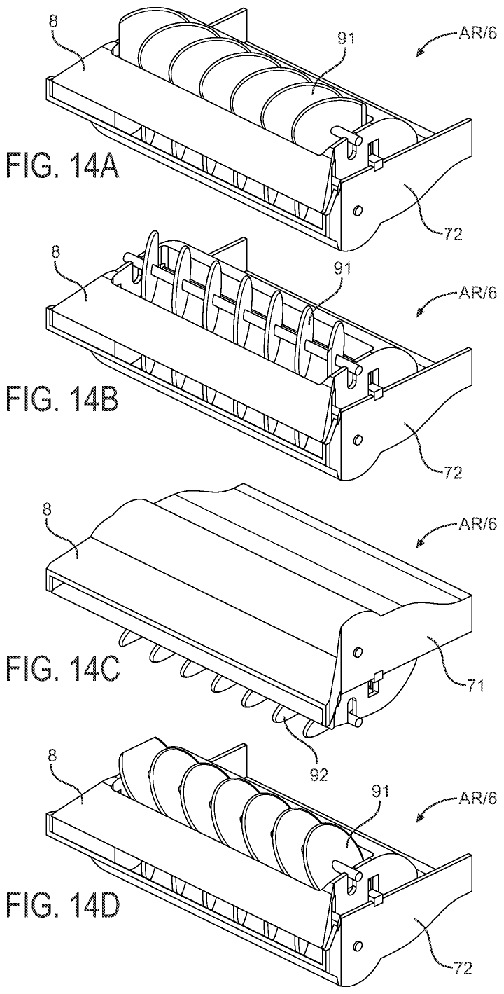

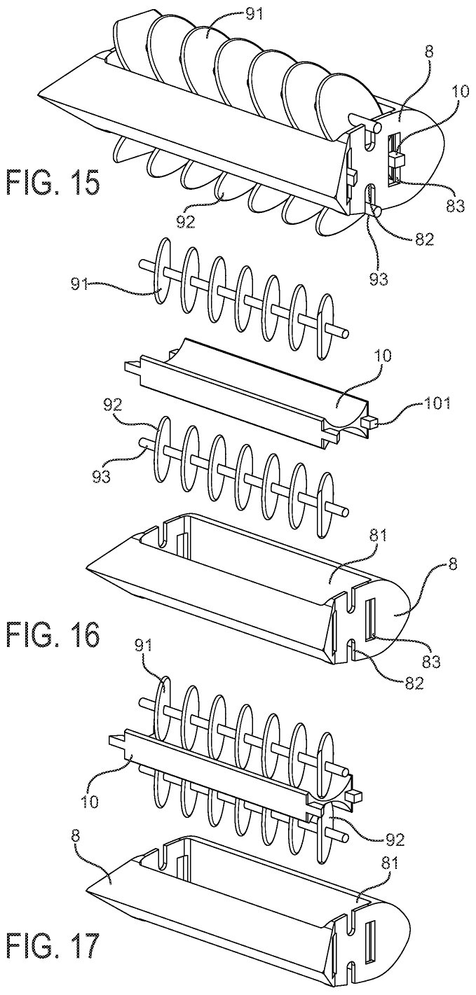

As shown schematically in FIGS. 15, 16 and 17, air guide blade assembly 9 may comprise two air guide blade sets 91 and 92 comprising a plurality of blades that may be obliquely arranged with respect to rotating shaft 93. As shown schematically in FIGS. 14A-14B, air guide blade sets 91 and 92 may rotate about blade rotating shaft 93 to adjust air blowing in the left and right directions of the air outlet. Diverter 8 may comprise a well 81 extending in a longitudinal direction, and both sides of diverter 8 may comprise a U-shaped groove 82 in which blade rotating shaft 93 may be installed and a square groove 83. Block 10 may comprise a partition plate. Block 10 may be between air guide blade sets 91 and 92. Block 10 may comprise a convex block 101. Block 101 may be positioned in square groove 83 to enable diverter 8 to move up and down relative to air guide blade sets 91 and 92 to adjust direction of air flow in up and down directions. See FIGS. 13A-13C, 14C and 14D.

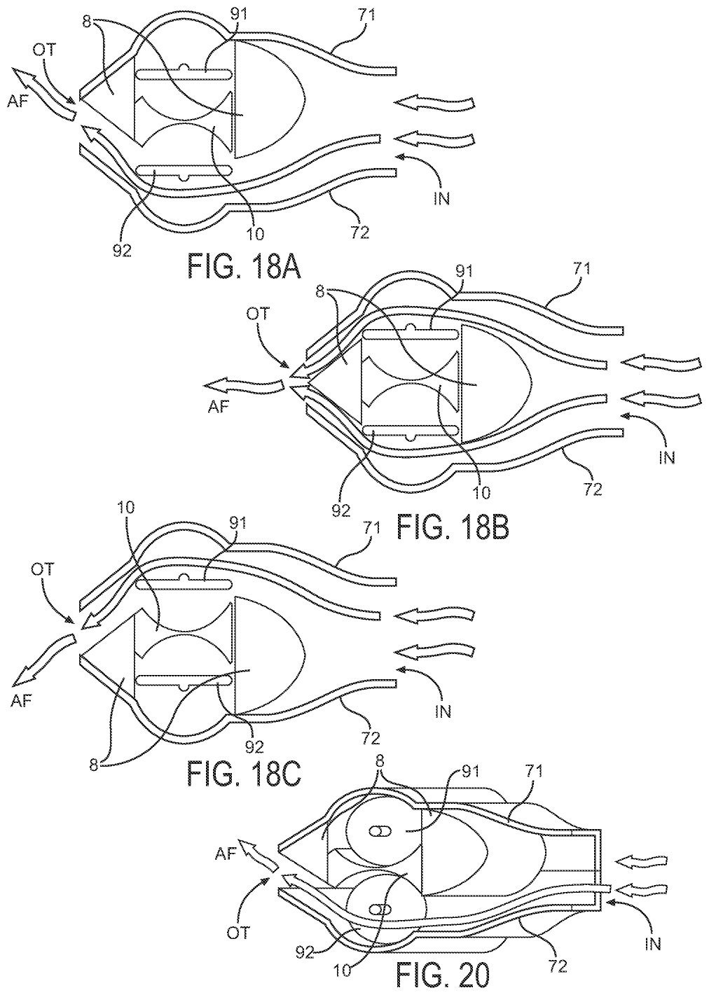

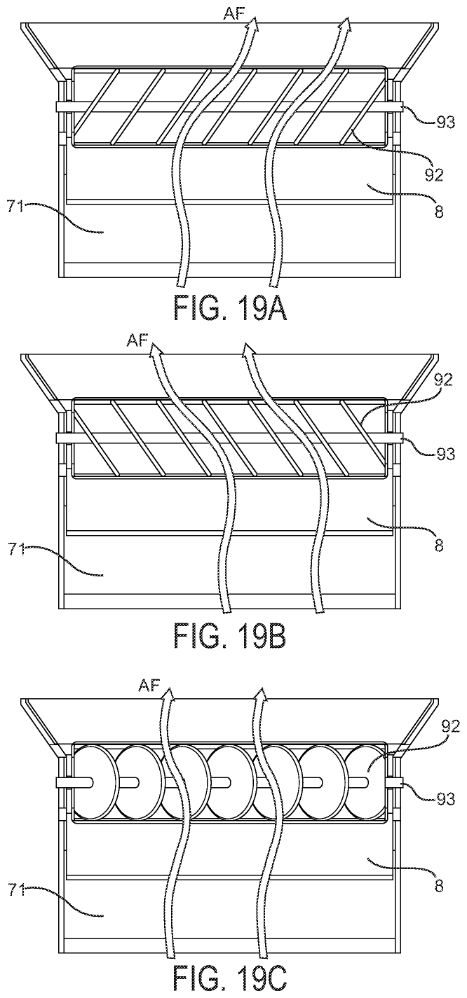

As shown schematically in FIGS. 18A-18C and 19A-19C, as blade sets 91 and 92 rotate about rotating shaft 93, the blowing direction of the air outlet is rightward when the extending direction of the blades deviates rightwards relative to the direction perpendicular to rotating shaft 93; when the extending direction of the blades deviates leftwards relative to the direction perpendicular to rotating shaft 93, the blowing direction of the air outlet is leftward; and when the extending direction of the blades is parallel to the direction perpendicular to rotating shaft 93, the blowing direction of the air outlet is towards the middle.

Rotation of air guide blade sets 91 and 92 around blade rotating shaft 93 and upward and downward movement of diverter 8 do not interfere with each other, and guide air flow leftwards and rightwards and upwards and downwards respectively. When air outlet assembly 6 blows air upwards and rightwards as shown schematically in FIG. 20, diverter 8 may be positioned at an upper portion of the housing, and air guide blade sets 91 and 92 may incline rightward so that the air flow is guided in an upper right direction at the inclination angle of the blades.

### Exemplary Embodiments—B

According to an exemplary embodiment, an air outlet assembly may comprise a movable air guide block to guide air flow upward and downward to provide an improved effective air outlet. Air guide blades may comprise ribs to adjust air blowing in left and right directions of the air outlet.

According to an exemplary embodiment, an air outlet assembly may comprise a housing and an air guide block assembled inside the housing. The air guide block may comprise a well. At least one set of air guide blades may be in the well to enable the air guide block to move longitudinally relative to the air guide blades. The air guide blade may comprise a blade rotating shaft extending in a vertical direction so that a single air guide blade may rotate around the blade rotating shaft. The air guide blade may comprise a plurality of sets of ribs with different heights, and the ribs on adjacent air guide blades may be interleaved. A profile of the rib may be substantially identical to an outer profile of an outer surface of the air guide block. At least one set of ribs may be substantially aligned with the upper or lower surfaces at a periphery of an opening of the well with respect to each longitudinal position of the air guide block. The opening side of the well may comprise a plurality of continuous curved surfaces. Two ends of the single curved surface may correspond to a limit rotation position of the single air guide blade. The profile of the single curved surface may be substantially identical to the rotation trajectory of the air guide blades. The guide blades may comprise two sets of air guide blades. A blade rotating shaft extending in a horizontal direction may be provided on an air guide blade so that the air guide blade rotates around the blade rotating shaft.

### Exemplary Embodiments—C

To regulate temperature of the interior of a vehicle, an air outlet assembly may be arranged on an instrument panel or an auxiliary instrument panel of the vehicle. The air outlet assembly may comprise a relatively slim opening for airflow out of the assembly.

A conventional air outlet assembly may include front and rear rows of blades to control upper and lower directions and left and right directions of air flow. When horizontal blades are used for guiding air up and down in an airflow assembly with a relatively slim opening for airflow out of the assembly, an effective area of the air outlet may be greatly reduced due to the influence of the thickness of the blades. Directivity of the air outlet may also be influenced.

An air outlet assembly may comprise a housing and an air guide block assembled inside the housing. The air guide block may comprise a well, and at least one set of air guide blades may be in the well to enable the air guide block to longitudinally move relative to the air guide blades. An air outlet of the air outlet assembly may be slim or slender.

TABLE A
REFERENCE SYMBOL LIST

| ELEMENT, PART OR COMPONENT | REFERENCE SYMBOL |
|---|---|
| vehicle | V |
| interior | I |
| instrument panel | IP |
| air outlet assembly | AR |
| housing | H |
| diverter | D |
| vertical guide mechanism | VM |
| air outlet assembly | 1 |
| housing | 2 |
| upper housing | 21 |
| lower housing | 22 |
| inlet | IN |
| outlet | OT |
| airflow | AF |
| diverter (air guide block) | 3 |
| cavity (well) | 31 |
| air guide blade set | 4 |
| rib | 41 |
| shaft | 42 |
| linkage | 43 |
| shaft | 44 |
| air outlet assembly | 6 |
| housing | 7 |
| upper housing | 71 |
| lower housing | 72 |
| diverter (air guide block) | 8 |
| Well | 81 |
| U-shaped groove | 82 |
| square groove | 83 |
| air guide blade assembly | 9 |
| air guide blade set | 91, 92 |
| blade rotating shaft | 93 |
| partition plate | 10 |
| partition plate convex block | 101 |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. An air outlet assembly for airflow in a vehicle interior comprising:
(a) a housing providing an outlet;
(b) a vertical guide assembly configured to guide airflow toward the outlet; and
(c) a diverter configured to guide airflow through the outlet;
wherein the diverter is configured to direct air from an inlet of the housing to the vertical guide assembly;
wherein the vertical guide assembly comprises a set of vertical guides;
wherein the set of vertical guides passes through the diverter.

2. The air outlet assembly of claim 1 wherein the diverter surrounds the set of vertical guides.

3. The air outlet assembly of claim 1 wherein the diverter comprises (a) a rear portion between an inlet of the housing and the set of vertical guides and (b) a front portion between the set of vertical guides and the outlet.

4. The air outlet assembly of claim 3 wherein the front portion and the rear portion are configured to translate relative to the housing and the set of vertical guides.

5. The air outlet assembly of claim 1 wherein the diverter is configured to translate in a vertical direction between a raised position and a lowered position.

6. The air outlet assembly of claim 1 wherein the set of vertical guides is configured to direct air side to side; wherein the diverter is configured to direct air up and down.

7. The air outlet assembly of claim 1 wherein the diverter is configured to translate relative to the set of vertical guides; wherein the set of vertical guides is configured to rotate relative to the diverter.

8. The air outlet assembly of claim 1 wherein a guide of the set of vertical guides is configured to rotate along a path; wherein the diverter comprises a curved surface aligned with the path.

9. An air outlet assembly for airflow in a vehicle interior comprising:
(a) a housing providing an outlet;
(b) a vertical guide assembly configured to guide airflow toward the outlet; and
(c) a diverter comprising a rear portion and a front portion;
wherein the rear portion is configured to direct air from an inlet toward the vertical guide assembly;
wherein the front portion is configured to guide airflow through the outlet;
wherein the vertical guide assembly is configured to guide airflow between the rear portion and the front portion.

10. The air outlet assembly of claim 9 wherein the vertical guide assembly is configured to guide airflow above the diverter; wherein the vertical guide assembly is configured to guide airflow below the diverter.

11. The air outlet assembly of claim 9 wherein the diverter comprises a unitary component comprising a wall connecting the front portion and the rear portion; wherein the wall, the front portion and the rear portion form an opening for the vertical guide assembly.

12. The air outlet assembly of claim 9 wherein the vertical guide assembly comprises a set of vertical guides configured to rotate relative to the diverter between a first terminal position and a second terminal position; wherein the diverter is configured to translate relative to the set of vertical guides between a lowered position and a raised position.

13. The air outlet assembly of claim 9 wherein the vertical guide assembly comprises a set of vertical guides; wherein the set of vertical guides extends above the diverter; wherein the set of vertical guides extends below the diverter.

14. An air outlet assembly for airflow in a vehicle interior comprising:
(a) a housing;
(b) at least one set of air guide blades inside the housing; and
(c) an air guide block inside the housing;
wherein the air guide block is configured to translate relative to the at least one set of air guide blades;
wherein the at least one set of air guide blades is configured to rotate relative to the air guide block;
wherein the air guide block comprises an opening;
wherein the at least one set of air guide blades is in the opening.

15. The air outlet assembly of claim 14 wherein the at least one set of air guide blades comprises an air guide blade comprising a shaft configured to rotate the air guide blade relative to the air guide block to adjust a direction of air flow through the housing.

16. The air outlet assembly of claim 14 wherein the at least one set of air guide blades comprises a first air guide blade and a second air guide blade; wherein the first air guide blade comprises a first set of ribs; wherein the second air guide blade comprises a second set of ribs; wherein the first set of ribs is staggered with the second set of ribs.

17. The air outlet assembly of claim 14 wherein the at least one set of air guide blades comprises an air guide blade comprising a rib; wherein the rib comprises a profile substantially identical to a profile of the air guide block.

18. The air outlet assembly of claim 14 wherein the air guide block comprises a plurality of continuous curved surfaces partially defining the opening, wherein a profile of a single curved surface of the plurality of continuous curved surfaces is substantially identical to a rotation trajectory of an air guide blade of the at least one set of air guide blades.

19. The air outlet assembly of claim 14 wherein the at least one set of air guide blades comprises a first set of air guide blades and a second set of air guide blades.

20. The air outlet assembly of claim 14 wherein the air guide block is configured to translate in a vertical direction relative to the at least one set of air guide blades between a raised position and a lowered position.
